(19) United States
(12) Patent Application Publication
(10) Pub. No.: US 2006/0196427 A1
(43) Pub. Date: Sep. 7, 2006

(54) Butterfly emergence chamber

(76) Inventor: Michelle Lepori, Cupertino, CA (US)

Correspondence Address: Lieberman & Brandsdorfer, LLC, 802 Still Creek Lane, Gaithersburg, MD, 20878, US

(21) Appl. No.: 11/360,263

(22) Filed: Feb. 23, 2006

Related U.S. Application Data
(60) Provisional application No. 60/655,520, filed on Feb. 23, 2005.

(51) Int. Cl. A01K 29/00

(52) U.S. Cl. 119/6.6; 119/6.5

(57) ABSTRACT

The present invention relates to a butterfly emergence chamber for displaying, shipping, growing, and releasing an insect larvae, pupae, and butterfly. More specifically, the present invention is comprised of a chamber with a stand and pupae attachment member. The pupae is suspended within the chamber and is provided with adequate growth conditions to mature. The chamber contains a removable stabilizing element that supports the pupae and prevents damage during shipment. Once, the pupae has matured into a butterfly, the chamber is adapted to release the butterfly.

### CROSS REFERENCE TO RELATED APPLICATION(S)

This is a non-provisional utility patent application claiming benefit of the filing date of U.S. provisional application Ser. No. 60/655,520 filed Feb. 23, 2005, and titled “Butterfly Emergence Chamber”, which is hereby incorporated by reference.

### BACKGROUND OF THE INVENTION

1. Technical Field

This invention generally relates to an apparatus and method for storage and delivery of butterflies. More specifically, the apparatus and method may be adapted such that an insect pupae may be suspended within an emergence chamber, shipped within the chamber, and that the chamber is suitable to allow for growth of the pupae into an adult and release of the adult.

2. Description Of The Relevant Art

This invention addresses some of the unmet needs in the emerging business of commercial trafficking of Butterflies to everyday consumers. In the past few years, the industry of rearing and sale of butterflies, called butterfly farming, has increased in popularity. This industry has focused on the sale of adult butterflies for release at weddings or eggs and larvae included in a rearing kit for education and research. Additionally, pupal forms of butterflies have been sold to institutional butterfly exhibits and individuals for the same purposes. In the latter case, pupae are usually shipped incased in sterile cotton or in receptacles cut into a block of cushioned material. The receiver of the cushioned pupae must remove the pupae from the shipping case and transfer it to an area where the pupae can finish development.

There are numerous limitations to the above structure and methods. First, the method and apparatus of shipping the pupae in a foam cut block may subject the pupae to unnecessary damage during shipment and may inhibit or cease the development or maturation of the pupae. Additionally, the foam block does not allow for adequate growth conditions of the pupae during shipment and may prevent the pupae from fully maturing. Moreover, the physical transfer of the pupae by the user from the cushioned block to the emergence chamber could also damage the pupae. Pupae must be oriented upside down and depending on the species be offset by an angle of as much as 45 degrees to allow natural emergence therefrom. When transferring the pupae to the emergence chamber, the pupae must be oriented correctly to allow for adequate growth and emergence from the cocoon. Failure to orient the pupae correctly could lead to death of the pupae.

Accordingly, there is a need for an apparatus in which a pupae may develop and be shipped within a single emergence chamber. This chamber should be designed to safely ship the pupae without causing damage to the pupae. Among the characteristics, this chamber should be sized to allow for adequate growth conditions of the pupae into an adult butterfly and release of the adult therefrom.

### SUMMARY OF THE INVENTION

The present invention relates to an apparatus for displaying, shipping, growing and releasing a butterfly. The apparatus is in the form of a portable chamber having walls, a top, and a bottom that create an interior and exterior. A stand and pupae attachment member are contained within the interior of the chamber. Together, the stand and pupae attachment member function to suspend the pupae within the chamber such that the pupae neither contacts the walls of the chamber nor the bottom of the chamber.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art illustration of a transport container.

FIG. 2 is an illustration of a pupae stand.

FIG. 3 is an illustration of a pupae stand with card elements and a base member.

FIG. 4 is an illustration of a pupae stand with a cantilevered arm.

FIG. 5 is an illustration of a pupae stand with intersecting horizontal members.

FIG. 6 is an illustration of attachment of a pupae to a horizontal frame member.

FIG. 7 is an illustration of a liquid adhesive fastener attachment to a horizontal frame member.

FIG. 8 is an illustration of a hook and loop fastener attachment to a horizontal frame member.

FIG. 9 is an illustration of a clip or pin attachment to a horizontal frame member.

FIG. 10 is an illustration of a spring attachment to a horizontal frame member.

FIG. 11 is an illustration of a pupae stabilizer.

FIG. 12 is an illustration of a chamber bottom that is configured to allow for release of the butterfly.

### DESCRIPTION OF THE PREFERRED EMBODIMENTS

### Technical Details

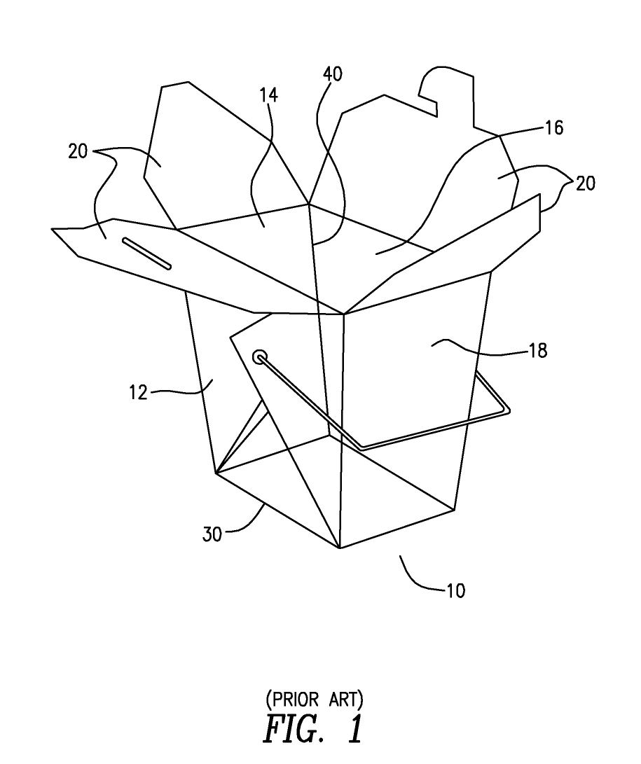

FIG. 1 illustrates a prior art portable lightweight chamber (10) with four walls (12), (14), (16), and (18), a top (20), and a bottom (30) that defines an interior section (40) of the chamber. Each of the walls and sections that form the chamber (10) may be made of a durable material to enable pupae housed within the chamber to receive air. In one embodiment, chamber material may be in the form of plastic, netting, paper, etc. The chamber (10) is configured to protect the pupae from natural events and predators. Such events may include, wind, changes in temperature, and natural weather events that may harm the pupae, and natural predators may include animals and insects that may harm the pupae and development thereof. This enables the pupae to develop properly without external disturbances. In one embodiment, at least one wall of the chamber may be transparent such that a user can view the developing pupae. Regardless of the number of transparent walls of the chamber, the safety measures to preserve the pupae remain intact. Similarly, an interior section (40) of the chamber (10) should be sized to accommodate a butterfly that develops from the pupae. In one embodiment, the chamber should be sized to about 150% of a final wingspan of the butterfly that should develop from the pupae. Although the chamber is shown with four walls in a linear arrangement, the chamber may come in different shapes and sizes that are not linear. For example, the chamber may be spherical. Accordingly, the size and dimensions of the chamber may come in various shapes.

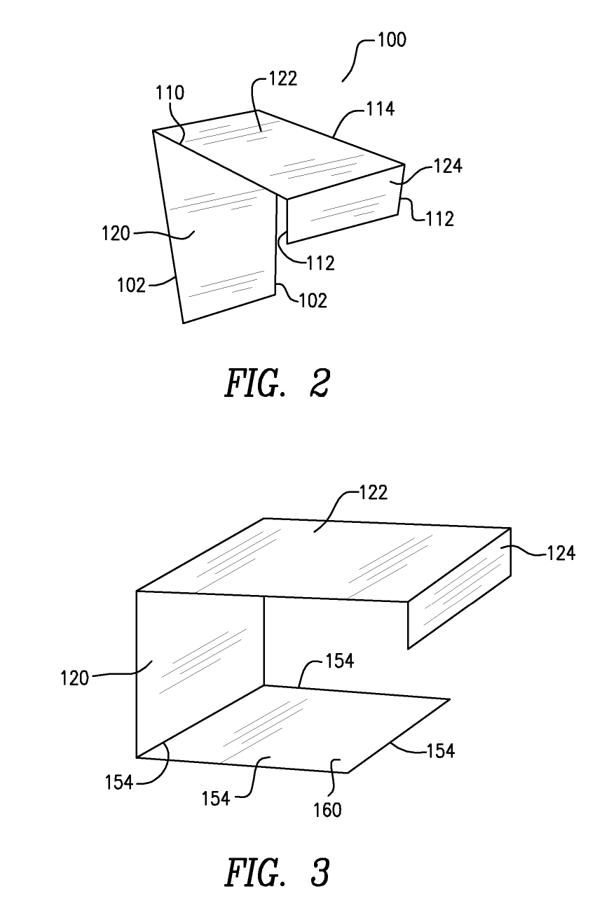

A stand is housed within the interior section (40) of the chamber (10). FIG. 2 is an illustration of the stand (100). As shown, the stand (100) includes a first set of vertical members (102), a second set of vertical members (112), a first horizontal member (110) parallel to the bottom (30) and extending along one of the walls perpendicular to the first and second vertical members (102) and (112), and a second horizontal member (114) parallel to the bottom (30) and extending along one of the walls of the chamber (10) parallel to the first horizontal member (110). The first vertical member (102) is approximately the height of one of the chamber walls. The second vertical member (112) is shorter in length than the first vertical member (102). The horizontal member (110) extends the distance from the first vertical member (102) to the second vertical member (112). In one embodiment, the stand (100) is sized according to the dimensions of the chamber (10). For example, the first vertical member (102) may be aligned with wall (12), the second vertical member (112) may be aligned with wall (16), and the horizontal member may be aligned with the top (20). Multiple cards are provided to solidify the stand (100) to provide support thereto. A first card (120) may extend the width of the stand (100) between the first vertical side members (102), i.e. parallel to the chamber wall member that extends between these two vertical members. A second card (122) may extend along the top portion (20) of the chamber (10) and parallel thereto, and a third card (124) is provided to extended between the set of second vertical member (112). In one embodiment, the stand (100) may be modified to include a base member. FIG. 3 is an illustration of the a stand (150) with base members (154). In one embodiment, the base members (154) may include a card (160) that extends the area formed by the member to form a planar base of the stand. In one embodiment, one or more of the cards may have a material on the surface thereof adapted to receive and retain indicia thereon. A visible surface of the card may include instructions pertaining to the care for the pupae and the respective life cycle of the particular species of butterfly housed within the chamber (10). Accordingly, the stand may be in the form of a skeleton without an interior body, or it may include card members to fill specified areas formed by the frame members.

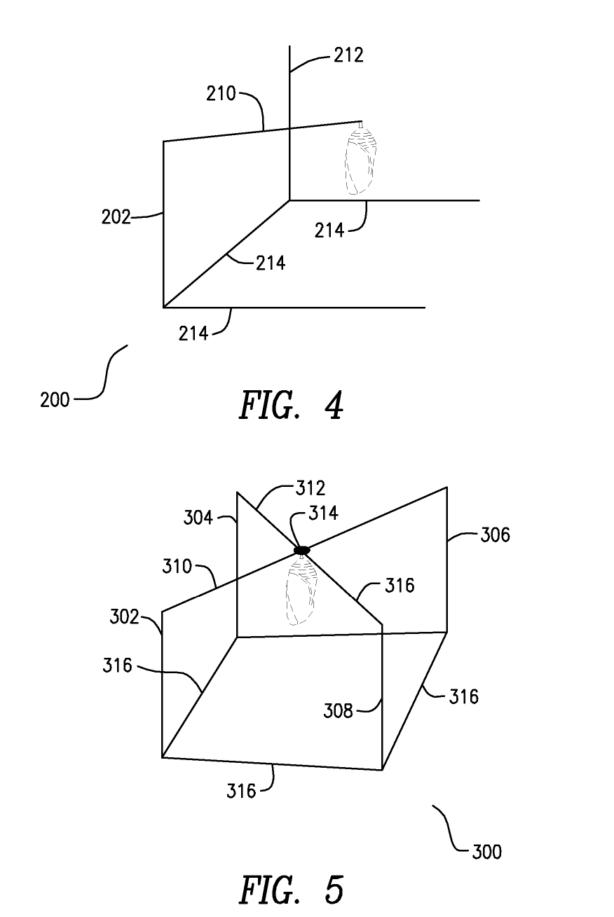

FIG. 4 is an illustration of the chamber (10) that is a variation from the chamber (10) shown in FIG. 2 without the cards. As shown, the chamber has a stand (200) housed therein. The stand (200) includes a first vertical side member (202), a second vertical member (212), a first horizontal member (210) parallel to the bottom (30), and a set of base member (214). The first vertical member (202) and the second vertical member (212) are both approximately the height of one of the chamber walls. The first and second vertical member (202) and (212) are parallel. The horizontal member (210) is a cantilevered arm that extends from a top portion of one of the vertical members (202) or (212) adjacent to a corner of the chamber (10) and extends in a planar direction to a central portion of the chamber (10).

FIG. 5 is an illustration of the chamber (10) that is a variation from the chamber (10) shown in FIG. 2 without the card members. As shown, the chamber has a stand (300) housed therein. The stand (300) includes a first vertical side member (302), a second vertical member (304), a third vertical member (306), and a fourth vertical member (308). Each of the vertical members (302)-(308) extend the height of the chamber adjacent to each corner thereof. The stand (300) includes a first horizontal member (310) and a second horizontal member (312), with both horizontal members (310) and (312) parallel to the bottom (30). The first and second horizontal members (310) and (312) are positioned so that they are adjacent to the top of the chamber, parallel to the base, and intersect. An intersection point (314) is preferably in a middle section of the top of the chamber. A pupae attachment member may be secured to the intersection point (314) of the horizontal members.

A pupae attachment member is provided to support the pupae within the interior section (40) of the chamber (10). The stand members and the pupae attachment member may come in different forms. For example, the stand members may be comprised of tubular or tubular like members. Such members may come in a material such as wire, metal, plastic, etc. The horizontal member(s) of the stand may include an extra support to accommodate the weight of the attachment member while continuing to support an attachment to the member. In all embodiments, the pupae attachment member acts to suspend the pupae within the chamber (10) such that the pupae does not come into contact with any of the four walls (12)-(18) or the bottom (30) of the chamber (10).

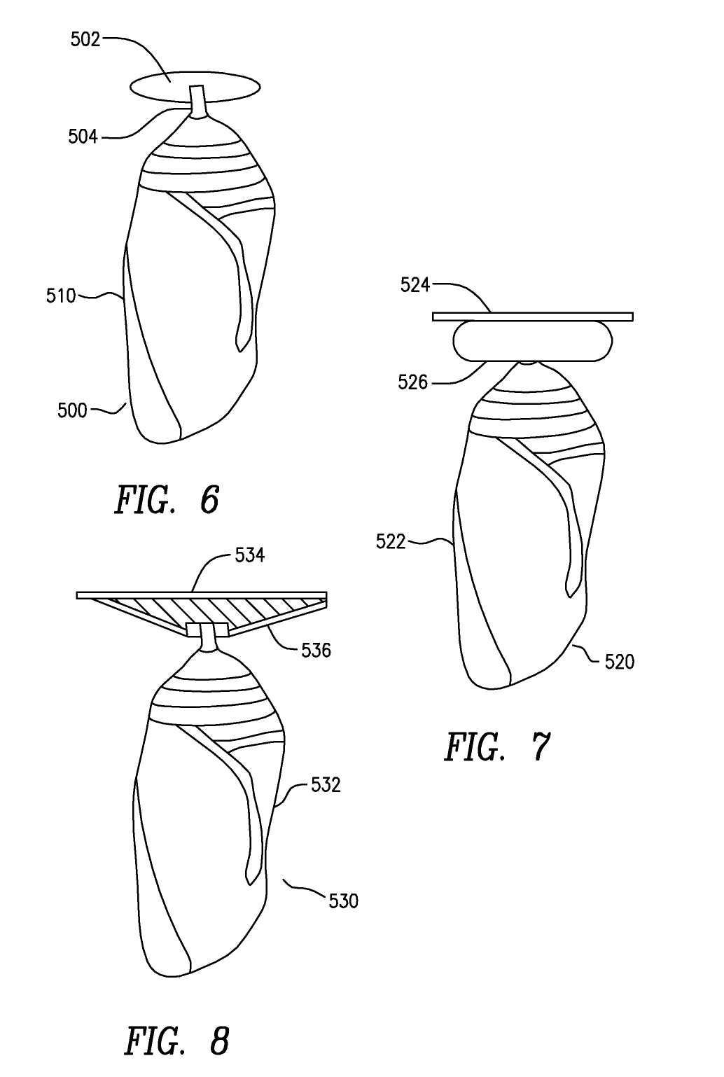

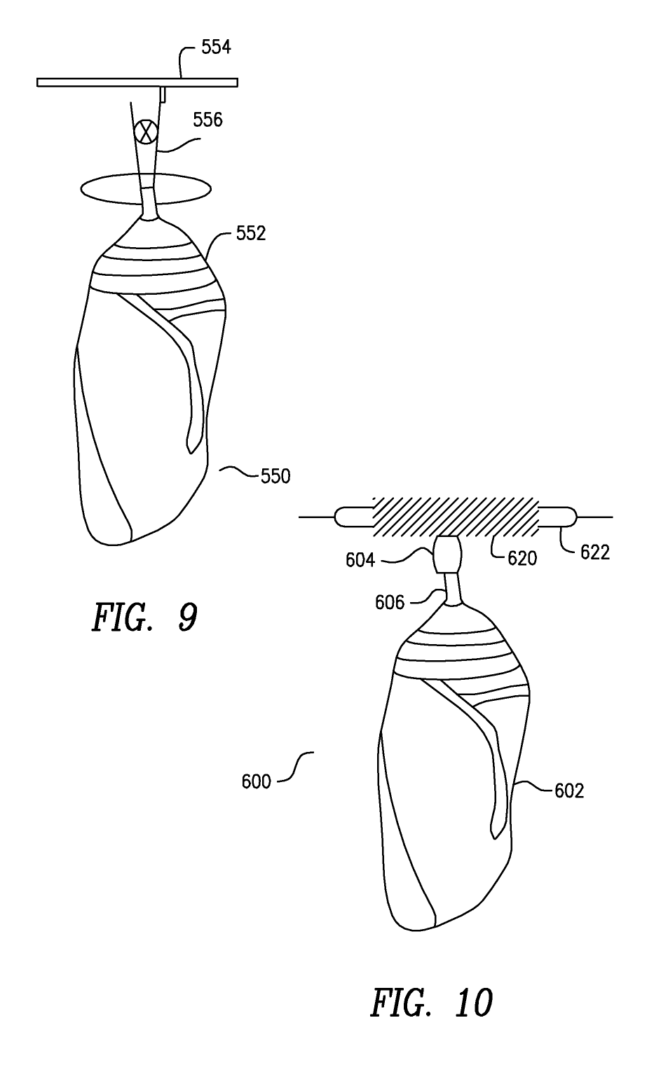

FIG. 6 is an illustration of one form of a pupae attachment member (500). As shown, a silk pad (502) is provided to secure to a horizontal member of the frame (not shown). The pupae (510) is secured to the silk pad (502) by a cremaster (504). FIG. 7 is an illustration of another form of a pupae attachment member (520). As shown, the pupae (522) is secured to a horizontal member of the frame (524) by means of a liquid adhesive (526). FIG. 8 is an illustration of another form of a pupae attachment member (530). As shown, the pupae (532) is secured to a horizontal member of the frame (534) by means of a hook and loop fastener (536). In one embodiment, the hook and loop fastener (536) may enable a gap to form between the pupae (532) and the horizontal member of the frame (534). FIG. 9 is an illustration of another form of a pupae attachment member (550). As shown, the pupae (552) is secured to a horizontal member of the frame (554) by a mechanical attachment (556). In one embodiment, the mechanical attachment may be in the form of a clip or a pin.

FIG. 10 is an illustration of another form of a pupae attachment member (600) in the form of a spring. As shown, the pupae (602) is held in a suspended state within the chamber (10) such that the pupae does not come into contact with any of the four walls (12)-(18) or the bottom (30) of the chamber (10). A silk pad (604) is provided that is secured at one end to a cremaster (606) and at a second end to a spring (620). The cremaster (606) extends from the pupae (602) to the silk pad (604). In one embodiment, the silk pad (604) is pinched into one or more coils of the spring (620). Following placement of the silk pad (604) in the coils of the spring (620), a tube (622) may be placed through the spring lumen to prevent the coils of the spring from opening due to the weight of the pupae or jostling. The tube re-enforces the ability of the spring to hold the pupae (602) in a suspended position. In one embodiment, the spring (620) could be held in a spaced apart relationship from the horizontal member of the frame or card by a string or wire.

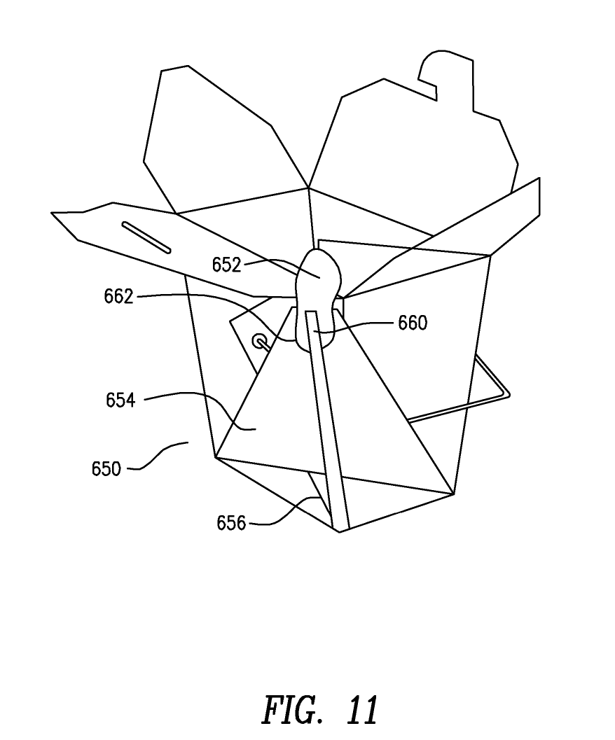

FIG. 11 illustrates a stabilizing element (650) to stabilize the pupae (652) during shipping. The stabilizing element (650) has two sections (654) and (656) that each extend diagonally across the base (30) of the chamber (10). In full extension and placement, the two sections (654) and (656) of the stabilizing element (650) intersect at a point (660). In one embodiment, the intersection point (660) includes an indentation (662) adapted to receive the bottom of the pupae (652) and to hold the pupae in a specified position and prevent it from moving within the chamber (10) during shipping. The stabilizing element (650) may be placed within the chamber (30) or removed from the chamber through one of the release mechanisms below. In one embodiment, the stabilizing element (650) is made of foam to absorb vibrations and other movements that could damage the pupae. Similarly, in one embodiment, the stabilizing element (650) is pyramid shaped so that the intersection point (660) is in a raised position to receive the pupae (652).

As illustrated in FIG. 12, the chamber (10) has a bottom (30) that is configured to allow for release of the butterfly. As illustrated in FIG. 12, the bottom (30) of the chamber (10) is comprised of four sections (702), (704), (706), and (708) each hingeably attached to a wall (12), (14), (16), and (18) of the chamber (10). Each bottom of the four sections is folded toward the interior of the chamber (10) and interconnects to form the bottom (30) of the chamber (10). The bottom sections (702), (704), (706), and (708) may be held together with a mechanical fastening element. To open the bottom (30) of the chamber (10), a force applied to the exterior side of the bottom (30) of the chamber (10) causes the bottom sections (702), (704), (706), and (708) to fold past the point of connection and into the interior of the chamber (10). This action creates an opening in the bottom of the chamber through which the butterfly may be released. In one embodiment, the top (20) of the chamber (10) may be modified to accommodate release of the butterfly. Similar to the bottom section illustrated in FIG. 12, the modified top section would be comprised of four sections, with each of these four sections hingeably attached to a wall of the chamber. Each of the four sections is configured to be folded toward the interior of the chamber and interconnected to form the top of the chamber. Two opposing top sections are adapted to interlock and hold the top in place. In use, a user may apply an outward force to the exterior side of the top of the chamber and cause the top sections to fold away from the point of connection and toward the exterior of the chamber. This action creates a hole in the top of the chamber and provides an opening for release of the butterfly.

In one embodiment of the release mechanism (not illustrated), at least one of the four walls of the chamber is perforated. When a user wishes to open the chamber, he/she applies an inward force on the perforated chamber wall causing the perforated chamber wall to separate. This separate creates a hole at the side of the chamber and releases the butterfly.

In one embodiment, the release mechanism may be in the form of a string provided at a connection point between the top of the chamber and two vertical walls of the chamber. The string is anchored on the interior side of one of the vertical walls of the chamber and extends through an opening at a connection point. When a user desires to open the chamber, he/she applies a force to the string causing the string to separate two of the chamber walls. This separation creates a hole at the side of the chamber and releases the butterfly.

In another embodiment, one or more peel back windows could be used to gain internal access to the chamber. Peel back windows could be resealed by returning them to their original position and pressing them against a internal ledge with a weak adhesive.

A porous material may be added to the interior of the chamber. The porous material functions to control the humidity within an interior section of the chamber (10). In one embodiment, a user may add the porous material saturated with water to the interior of the chamber (10) to maintain a constant humidity within the chamber (10). As water evaporates from the porous material, the porous material may be re-hydrated through small holes or folds within at least one of the four walls (12)-(18) of the chamber. Preferably, the porous material may be made of a sponge material or cotton.

### Alternative Embodiments

It will be appreciated that, although specific embodiments of the invention have been described herein for purposes of illustration, various modifications may be made without departing from the spirit and scope of the invention. In particular, alternative attachment mechanisms may be provided to secure the pupae within the chamber at a proper angle to enable the pupae to be transported while maintaining a proper upside down position for completion of the growth to a butterfly. Similarly, alternative release mechanisms may be provided to open one or more walls or surfaces of the chamber to enable the butterfly to safely emerge from the container into nature. In addition, the arm to support the pupae attachment is shown as a part of a stand that may be integral with or separate from the chamber. This arm may be a part of the container, or it may be separate from the container to enable the pupae attachment to be apart of or separable from the chamber.

We claim:

1. An apparatus for displaying and shipping a pupae comprising:
(a) a chamber with walls, a top and a bottom, all of which separate an interior from an exterior of said chamber, and at least one of said walls, top and bottom is permeable by air;
(b) at least one arm within said interior of said chamber, wherein said arm extends adjacent to at least one of said walls of said chamber; and
(c) a pupae attachment member that extends from said arm, wherein said attachment member is adapted to suspend a pupae within said chamber and mitigate contact of said pupae with any of the walls and bottom of said chamber.

2. The apparatus of claim 1, wherein said chamber is comprised of a material that provides protection to said pupae, wherein said protection is selected from a group consisting of: protection from predators, protection from wind, insulation to the interior of said chamber, and combinations thereof.

3. The apparatus of claim 2, wherein said material is selected from a group consisting of: plastic, netting, and paper.

4. The apparatus of claim 1, wherein at least one of said walls of said chamber is transparent.

5. The apparatus of claim 1, wherein said interior of said chamber has a volume is greater than a final wing span of a butterfly intended to emerge from said pupae.

6. The apparatus of claim 1, wherein said pupae attachment member is located on said horizontal arm at approximately a center of the top of the chamber.

7. The apparatus of claim 6, further comprising a card in communication with said horizontal arm, said card adapted to be mounted adjacent to said top of said chamber to provide shade for the pupae.

8. The apparatus of claim 7, wherein a exterior side of said card is adapted to receive indicia.

9. The apparatus of claim 8, wherein said indicia is selected from a group consisting of: care instructions for said pupae, life cycle data of a particular species of butterfly, and combinations thereof.

10. The apparatus of claim 1, said stand further comprising a skeletal frame, each horizontal arm extends diagonally across said top of said chamber, with said pupae attachment member mounted at an intersection point of said horizontal arms.

11. The apparatus of claim 10, wherein said frame is adapted to be separated from said container.

12. The apparatus of claim 1, further comprising said stand having a skeletal base that extends adjacent to a perimeter of said bottom of said chamber, a vertical arm connected to said base, and a horizontal arm connected to a top point of said vertical arm and extends into a central portion of said chamber in a cantilevered position, and said pupae attachment element extending from the distal end of the cantilevered horizontal arm.

13. The apparatus of claim 1, wherein said pupae is secured to a silk pad by a cremaster and said pupae attachment member suspends said pupae by said silk pad.

14. The apparatus of claim 1, wherein said pupae is secured to a silk pad by a cremaster and said pupae attachment member suspends said pupae by said cremaster.

15. The apparatus of claim 1, wherein said pupae attachment member is selected from a group consisting of: an adhesive, a hook and loop system, tape, a clip assembly, and a spring.

16. The apparatus of claim 1, wherein a porous material is contained within said interior of said chamber and is adapted to absorb and release water and at least one of said walls of said chamber are adapted to allow a user to re-hydrate said porous material.

17. The apparatus of claim 1, further comprising a stabilizing element mount within said interior of said chamber adjacent to said bottom and adapted to hold said pupae in a set position.

18. The apparatus of claim 1, wherein a section of said chamber is adapted to fold inward toward the interior of said chamber and create an opening in said chamber for release of a butterfly, said section of said chamber is selected from a group consisting of: said bottom, said top, one of said walls, and combinations thereof.

19. The apparatus of claim 1, further comprising a string anchor attached to at least one of said walls of said chamber and is contained at a connection point between said top of said chamber and two of said walls of said chamber such that when a downward force is applied to said string at least two of said chamber walls separate.

20. The apparatus of claim 1, further comprising a releasable attachment means adapted to hold together said the four walls, said top, and said bottom of said chamber, such that when one or more of said attachment means are removed, said wall, said top and said bottom of said chamber become unlocked and able to be removed from the chamber creating an opening within said chamber, said attachments means is selected from a group consisting of: a pin, a clip, and combinations thereof.

21. The apparatus of claim 1, further comprising a window having a covering with a releasable adhesive material adapted to be releaseably secured to a wall portion adjacent to said window.
